(19) United States
(12) Patent Application Publication
(10) Pub. No.: US 2006/0178813 A1
(43) Pub. Date: Aug. 10, 2006

(54) Auxiliary method for setting vehicle satellite navigating destinations

(75) Inventor: Stephen Chen, Changhua (TW)

Correspondence Address: BRUCE H. TROXELL;SUITE 1404, 5205 LEESBURG PIKE, FALLS CHURCH, VA, 22041, US

(73) Assignee: E-Lead Electronics Co., Ltd.

(21) Appl. No.: 11/050,871

(22) Filed: Feb. 7, 2005

(51) Int. Cl. G01C 21/34

(52) U.S. Cl. 701/202; 701/209; 340/995.19

(57) ABSTRACT

An auxiliary method for setting vehicle satellite navigating destinations aims to build a destination file from electronic map data of Web pages of a Web site. The data source of the destination file may be retrieved by E-mail. The destination file data are downloaded by radio transmission or through a memory card into a memory unit of a navigation host to enable the navigation host to perform navigation route planning thereby to overcome the problem of inadequate data or poor usability occurred to the conventional route planning.

### BACKGROUND OF THE INVENTION

1. Field of the Invention

The invention relates to an auxiliary method for setting vehicle satellite navigating destinations to assist users to set destinations in a vehicle navigation host.

2. Description of the Prior Art

In the past driving a car to a destination relies on maps by following the roads shown thereon. Due to fast business and community developments, the road system becomes very complicated. Nowadays it is not uncommon that even a destination a few blocks away could be difficult to reach directly due to the restrictions of one-way streets, no-left turn roads, overpasses, rivers, and the like. Hence a desired driving route often has to be planned ahead. The navigation system now equipped in many vehicles is a helpful tool for drivers to select the optimum route. However at present setting a destination on the vehicle navigation host mostly has to use a remote controller to do selection or search on the map. The remote controller has a limited number of keys. Hence users have to move slowing through the direction keys to the destination to do setting, or move to a landmark close to the destination (such as a government building, park, or the like), then move the direction keys from the landmark to the desired destination for setting. It is inconvenient, and also does not conform to the using habit of most users. As users generally know the street or road and city of the destination before searching, to find out the destination through the direction keys on a display screen about seven inches or smaller is not practical or helpful.

Moreover, nowadays many people planning their travel and trip by accessing the Internet and downloading the geographic location of the visiting areas or hotels. Users generally have to print the maps appeared on the Web pages and use the maps as the guide during actual driving. It also is not convenient.

### SUMMARY OF THE INVENTION

Therefore the object of the present invention is to resolve the disadvantages of the conventional vehicle navigation host such as difficult to set destinations and not practical. The present invention provides an auxiliary method for setting vehicle satellite navigating destinations. The method includes a procedure as follow:

(1) selecting a destination file from Web pages on a Web site;

(2) downloading the destination file into a navigation host;

(3) setting up an interim file in the memory unit of the navigation host;

(4) starting the navigation host to check and update the interim file; and

(5) planning the navigation route.

In the auxiliary method set forth above, the data source of the destination file is outside the navigation host, such as selecting from Web pages of a Web site, and is downloaded into the memory unit of the navigation host through radio transmission or a memory card.

In one aspect, the Web pages have electronic maps corresponding to the navigation system of the navigation host. Users or other people can select a destination on the maps to set up a destination file.

In another aspect, the destination file includes at least longitude and latitude data of the destination.

In yet another aspect, the destination file includes one or more picture related to the destination to be displayed on the navigation host to show the exact appearance of the destination.

In still another aspect, the destination file includes address data.

In another aspect, the destination file may be expanded to become a destination file folder which contains one or more destination file.

In another aspect, the destination file has a sub-file name consisting of common and selected characters for identification.

In another aspect, the navigation host includes one or more memory unit which contains a data file of a preset destination, and one or more interim file which may be updated anytime desired.

In another aspect, the navigation host includes one or more memory unit which may be a removable memory card device.

In another aspect, the navigation host includes a software for reading the interim file to set a navigation route to the destination, and to search as desired files stored in the memory card that have been added or modified, and treat the file data as the destination file for user selection to serve the destination of the navigation route.

In another aspect, the navigation host includes a software which has a directory for destination selection. The directory has a menu named by the destination file name or destination file folder so that when user selects the menu item the navigation host opens the destination file or folder.

In another aspect, the source of the destination file is obtained by E-mail.

In another aspect, the destination file data include visiting site introductions appeared on the Web pages that have location information on the electronic map for setting up a destination file.

In another aspect, the destination file includes interesting spots such as restaurants, hotels, shopping stores, service centers, entertainment sites, amusement parks, gas stations, and the like.

By means of the invention, the electronic maps on the Web pages of a Web site may be selected to build a destination file. Interesting spots may be selected and planned and added to the destination file. The destination file data may be obtained by E-mail, and may also be downloaded to the navigation host for planning the navigation route. Thus it can overcome the problems occurred to the conventional routing data that are not adequate or practical.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the structure of the navigation host of the invention.

FIG. 2 is the main flow chart of the method of the invention.

FIG. 3 is the secondary flow chart-1 of the invention.

FIG. 4 is the secondary flow chart-2 of the invention.

FIG. 5 is a flow chart for entering the destination in the navigation host of the invention.

FIG. 6 is another flow chart for entering the destination in the navigation host of the invention.

### DESCRIPTION OF THE PREFERRED EMBODIMENTS

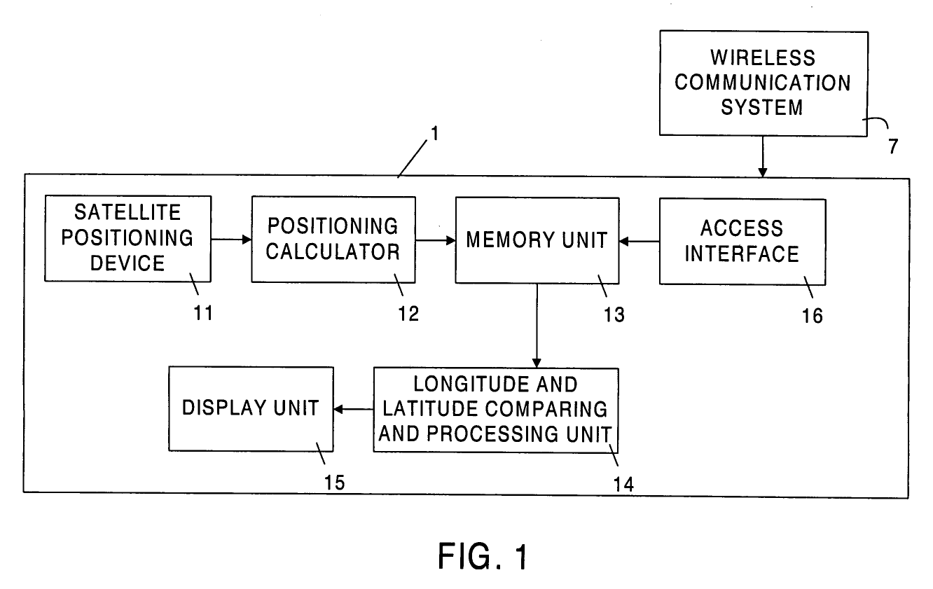

Referring to FIG. 1, the navigation host 1 according to the invention includes:

a satellite positioning device 11 to receive satellite signals;

a positioning calculator 12 to receive the signals of the satellite positioning device 11 for downstream processing;

a memory unit 13 to store data of the navigation host 1, such as maps, destination data, and the like. It contains one or more destination data file and one or more interim file which may be updated anytime;

a longitude and latitude comparing and processing unit 14 to receive the signals of the satellite positioning device 11 and mate the electronic maps of the memory unit 13 to mark the location of the navigation host 1;

a display unit 15 to display the navigation maps, current position and other related data; and

an access interface 16 to receive external data, such as read/write interfaces including infrared transceivers, radio transceivers (FM, AM, wireless LAN), Bluetooth transceivers, card readers (CF, MD, SM, SD, MMC, MS), optical disk drives, and the like.

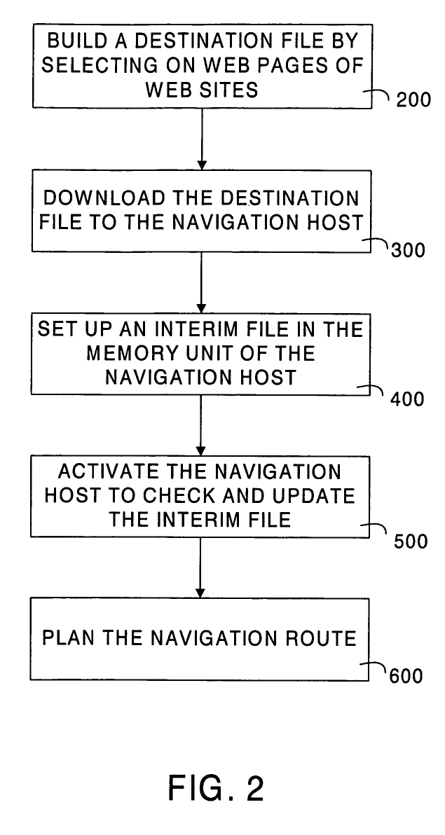

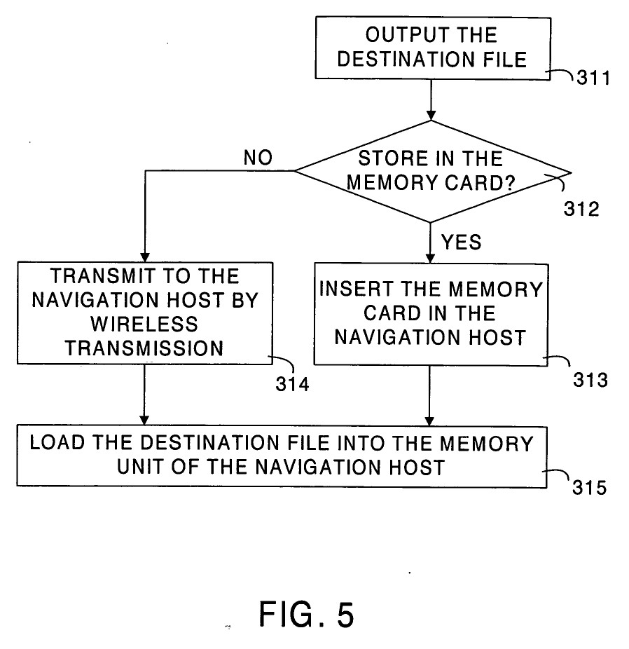

By means of the construction set forth above, a user can use a network device to link and access Web sites to search destinations, and select the ones desired on the map of the Web pages, and order the Web page program to generate a destination file to be used by the vehicle navigation host 1. The procedure (referring to FIG. 2) is as follow: p1 (1) select a destination file on the Web pages of a Web site (step 200): link the network to the Web site which has electronic maps compatible to the navigation host 1. Search a destination desired through the electronic map program of the Web site by maps or keywords. Once the destination is chosen, user can add related text descriptions or pictures, and set up a destination file with a sub-file name. The file includes the longitude and latitude coordinates of the destination, and the text and pictures entered by the user;
(2) download the destination file into the navigation host (step 300): after the destination is set up (referring to FIG. 5), the file may be output and stored in a memory card (step 311 and 312). Insert the memory card into the navigation host (step 313). The navigation host reads or downloads the destination file into the memory unit 13 (step 315). Or transfer the destination file by radio transmission to the navigation host 1 (step 314 and 315) through a wireless communication system 7 such as a GSM or CDMA module (also referring to FIG. 1). The wireless communication system 7 can transmit the destination file to the navigation host 1;
(3) build an interim file in the memory unit of the navigation host (step 400): the memory unit 13 of the navigation host 1 has a preset destination data file and an interim file which may be updated anytime desired. When the destination file is transmitted to the memory unit 13, it is stored in the interim file;
(4) start the navigation host to check and update the interim file (step 500): when the navigation host 1 starts operation, it checks whether there are updating data for the content of the interim file. If yes, update the file; and
(5) plan the navigation route (step 600): the navigation host 1 configures a route to the destination according to the longitude and latitude data in the interim file, and stores the route in the destination data file to be used in the navigation process.

The navigation host 1 includes a software for reading the interim file to set the destination of the navigation route.

The destination file may be expanded to become a destination file folder with a common sub-file name. The navigation host 1 can selectively read the sub-file name like inquiring a directory to search the destination file or destination file folder. It also serves as a basis to differentiate the external destination files.

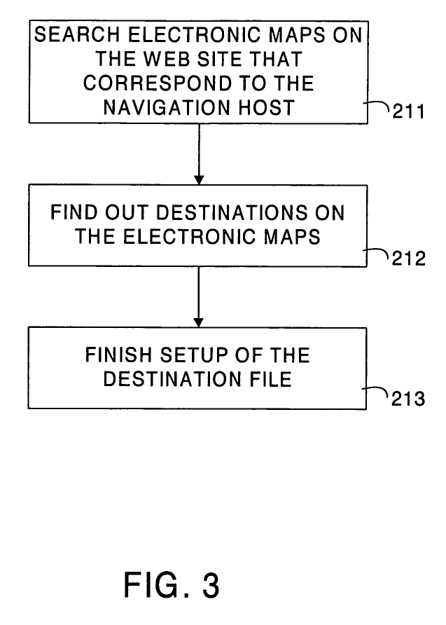

In the step 200 of select a destination file on the Web pages of a Web site as shown in FIG. 3, first, search the electronic maps on the Web site that correspond to the navigation host 1 (step 211); next, find out the destination on the electronic maps (step 212); then finish setup of the destination file (step 213).

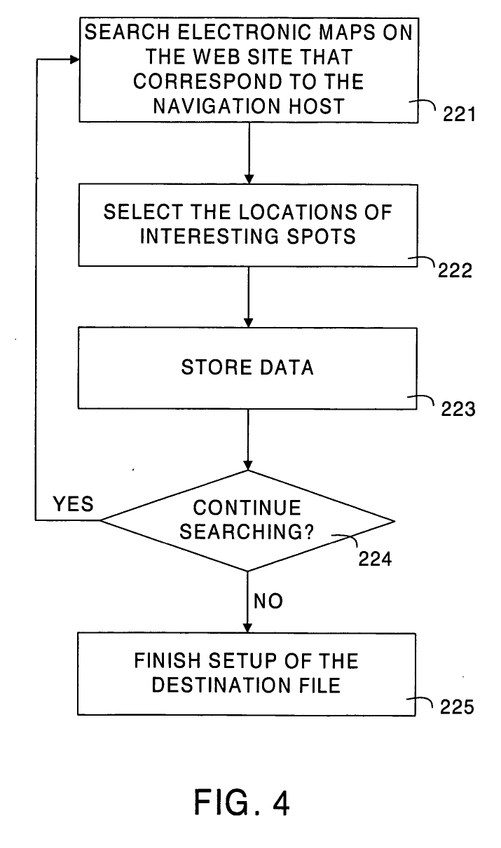

Moreover, in the step 200 of select a destination file on the Web pages of a Web site, the destination file data include site introductions from the Web pages. As shown in FIG. 4, first, search the electronic maps corresponding to the navigation host 1 on the Web site (step 221); select the interesting spot location on the electronic maps (step 222); store data (step 223); continue selection and searching (step 224); finish setup of the destination file (step 225). The destination file further includes introduction text, pictures, special scenic sites, folklore and special features. The interesting spots may include landmarks such as restaurants, hotels, shopping stores, service centers, entertainment sites, amusement parks, gas stations, and the like.

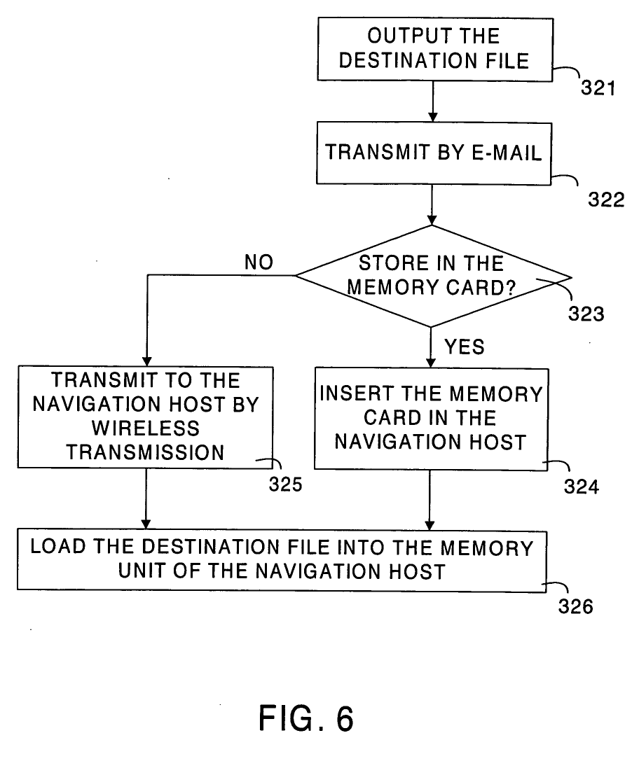

In the step 300 of download the destination file into the navigation host, the destination file may be sent by E-mail to a computer or handset of the user of the navigation host 1. Then the file is transmitted to the navigation host 1 according to the procedure shown in FIG. 6. Namely, output the destination file (step 321); transmit the file by E-mail (step 322); store the file in a memory card (step 323); insert the memory card into the navigation host 1 (step 324); load the destination file into the memory unit 13 of the navigation host 1 (step 326); or output the destination file directly by wireless transmission to the memory unit of the navigation host 1 (step 325 and 326).

In summary, the invention provides a method for setting destination that better suits the habits of people and computer users. It overcomes the restrictions occurred to the conventional navigation system. It also breaks the limitation of the conventional technique that displays only maps or address text. Instead, a destination file is directly delivered to the navigation host in the vehicle so that users can find out the geographical location easily.

I claim:

1. An auxiliary method for setting vehicle satellite navigating destinations, comprising the steps of:
(1) building a destination file by selecting from Web pages of a Web site;
(2) downloading the destination file into a navigation host;
(3) establishing an interim file in a memory unit of the navigation host;
(4) activating the navigation host to check and update the interim file; and
(5) planning a navigation route.

2. The auxiliary method of claim 1, wherein the memory unit of the navigation host contains at least one preset destination file and at least one interim file which is subject to updating anytime desired.

3. The auxiliary method of claim 1, wherein the destination file includes the longitude and latitude coordinates of a destination selected by users.

4. The auxiliary method of claim 1, wherein the destination file includes highlight text and pictures entered by users.

5. The auxiliary method of claim 1, wherein the destination file is built from external data sources outside a navigation host, and selected from the Web pages of the Web site, and downloaded through a memory card into the memory unit of the navigation host.

6. The auxiliary method of claim 1, wherein the destination file is built from external data sources outside a navigation host, and selected from the Web pages of the Web site, and downloaded by radio transmission into the memory unit of the navigation host.

7. The auxiliary method of claim 1, wherein the destination file is built from a data source transmitted by E-mail.

8. The auxiliary method of claim 1, wherein the destination file includes introductions of interesting spots from the Web pages, the interesting spots being locatable on electronic maps on the Web pages to be built in the destination file.

9. The auxiliary method of claim 8, wherein the interesting spots include restaurants, hotels, shopping stores, service centers, entertainment sites, amusement parks and gas stations.
